(19) United States
(12) Patent Application Publication
(10) Pub. No.: US 2026/0161600 A1
(43) Pub. Date: Jun. 11, 2026

(54) METHOD AND DEVICE FOR CONVERTING FILES

(71) Applicants: HYUNDAI MOTOR COMPANY, Seoul (KR); KIA CORPORATION, Seoul (KR)

(72) Inventors: Yonghee Lee, Hwaseong-si (KR); Woo Sung Lee, Hwaseong-si (KR)

(73) Assignees: HYUNDAI MOTOR COMPANY, Seoul (KR); KIA CORPORATION, Seoul (KR)

(21) Appl. No.: 19/393,165

(22) Filed: Nov. 18, 2025

(30) Foreign Application Priority Data
Dec. 6, 2024 (KR) 10-2024-0180866

(51) Int. Cl. G06F 16/11; H04L 12/40

(52) U.S. Cl. CPC G06F 16/116; H04L 12/40169; H04L 2012/40215; H04L 2012/40273

(57) ABSTRACT

A file conversion method includes receiving a first type controller area network (CAN) database container (DBC) file and receiving a configuration file including a CAN equipment name, a path of the first type CAN DBC file, a message name, a signal name, and information about a receiving device. The filing conversion method also includes parsing the configuration file to extract the signal name, extracting a line corresponding to the signal name extracted from the configuration file from the first type CAN DBC file, and generating a first data frame by configuring an information included in the line according to a second type format different from the first type. The file conversion method additionally includes generating a second data frame by converting the values of some items from the first data frame into another format and generating a second type CAN DBC file based on the second data frame.

### CROSS-REFERENCE TO RELATED APPLICATION

This application claims priority to and the benefit of Korean Patent Application No. 10-2024-0180866 filed with the Korean Intellectual Property Office on Dec. 6, 2024, the entire contents of which are hereby incorporated herein by reference.

### BACKGROUND

### (a) Technical Field

The present disclosure relates to a method and a device for file conversion, and more specifically, to a method and a device for converting a controller area network (CAN) database container (DBC) file including CAN communication-related information into another type.

### (b) Description of the Related Art

The development of a purpose built vehicle (PBV) has brought about a major change in automobile industry, and an external platform for vehicles equipped with PBV is designed to perform specific functions depending on the purpose. At the heart of this technology ecosystem is a Controller Area Network (CAN) bus that enables an efficient data exchange between various electronic control units (ECUs) within the vehicle and external platforms. As the PBV vehicles are designed for a variety of purposes and the complexity and volume of the data required increases, the gateway role of the CAN bus becomes increasingly important. However, a database container (DBC) automatic creation system for efficient use of the gateway has not currently been established.

Currently, there is no system to automatically convert or generate the vehicle CAN DB, which causes various problems. First, it takes a lot of time to create the CAN DB. Currently, the CAN DB using a tool provided by a VECTOR must be manually edited, which takes at least 2 hours and up to 8 hours or more. Second, human errors that occur during the manual editing of the CAN DB may lead to DB errors, which in turn increases the risk of rework and time loss. Third, the data lacks flexibility. The editing and monitoring in the VECTOR tools are limited to a specific format, which does not guarantee a compatibility with other formats, and there is limited flexibility in converting or saving to data formats required by external platforms.

### SUMMARY

Embodiments of the present disclosure provide a method and a device for file conversion that provide a library that automatically generates a gateway DBC for an efficient routing of CAN data between a vehicle and an external platform.

According to an embodiment, a file conversion method for converting a controller area network (CAN) database container (DBC) file including information related to CAN communication into another type is provided. The file conversion method includes receiving, by a processor, a first type CAN DBC file. The file conversion method also includes receiving, by the processor, a configuration file including a CAN equipment name, a path of the first type CAN DBC file, a message name, a signal name, and information about a receiving device. The file conversion method additionally includes parsing, by the processor, the configuration file to extract the signal name and extracting, by the processor from the first type CAN DBC file, a line corresponding to the signal name extracted from the configuration file. The file conversion method further includes generating, by the processor, a first data frame by configuring information included in the line according to a second type format different from the first type CAN DBC file. The file conversion method also includes generating, by the processor, a second data frame by converting values of at least some items from the first data frame into another format. The file conversion method additionally includes generating, by the processor, a second type CAN DBC file based on the second data frame.

In some embodiments, the configuration file may include a plurality of CAN equipment names. The configuration file may store the path, the message name, the signal name, and the information about the receiving device in a grouped format for each of the plurality of CAN equipment names.

In some embodiments, extracting the line corresponding to the signal name may include: sequentially reading, by the processor, the first type CAN DBC file in one direction; determining whether the signal name is included in a first line being read from the first type CAN DBC file; extracting, by the processor, the first line based on determining that the signal name is included in the first line; determining whether a second line being read after the first line from the first type CAN DBC file includes the signal name; and extracting, by the processor, the second line based on determining that the signal name is included in the second line.

In some embodiments, extracting the line corresponding to the signal name may include extracting, by the processor, a message line, a content line, an item line, and a value line corresponding to the signal name from the first type CAN DBC file.

In some embodiments, generating the first data frame may include: storing, by the processor, information included in the first line and information included in the second line into the memory; analyzing, by the processor, the information included in the first line and the information included in the second line according to a predetermined message frame and signal format to extract information about the signal name, a start bit, a signal size, a message type, a message name, an identifier, a message size, a cycle, a transmitter, a net name, whether a standardization is applied, and the receiving device; and generating, by the processor, the first data frame so as to include the extracted information.

In some embodiments, generating the second data frame may include: reading, by the processor, the message size from the first data frame; and changing, by the processor, a value of the message size to a different value according to a protocol to be changed.

In some embodiments, generating the second data frame may include reallocating, by the processor, the start bit based on the signal size.

In some embodiments, generating the second data frame may further include grouping, by the processor, messages for each cycle among a plurality of cycles and changing a message name of the messages grouped by the cycle.

In some embodiments, generating the second data frame may further include grouping, by the processor, messages for each identifier among a plurality of identifiers, sorting the message based on the identifier, and changing the identifier for the sorted messages.

In some embodiments, generating the second type CAN DBC file may include dividing, by the processor, the second data frame by the receiver to generate a plurality of second type CAN DBC files.

According to another embodiment, a file conversion device is provided. The file conversion apparatus includes one or more non-transitory computer-readable media including instructions and one or more processors configured to execute the instructions to: receive a first type CAN DBC file; receive a configuration file including a CAN equipment name, a path of the first type CAN DBC file, a message name, a signal name, and an information about the receiving device; parse the configuration file to extract the signal name; extract a line corresponding to the signal name extracted from the above configuration file in the first type CAN DBC file; generate a first data frame by configuring the information included in the line according to a second type format different from the first type; generate a second data frame by converting the values of some items in the first data frame to a different format; and generate a second type CAN DBC file from the second data frame.

In some embodiments, the configuration file may include a plurality CAN device names. The configuration file may store an information about the path, the message name, the signal name, and the receiving device in a grouped format for each of the CAN device names.

In some embodiments, extracting the line corresponding to the signal name may include determining whether the first line being read includes the signal name while sequentially reading the first type CAN DBC file in one direction; extract the line based on determining that the signal name is included in the first line; determine whether the second line being read after the first line includes the signal name while reading the first type CAN DBC file in one direction; and extract the line based on determining that the signal name is included in the second line.

In some embodiments, generating the first data frame may include: storing information included in the first line and information included in the second line into a memory; analyzing the information included in the first line and the information included in the second line to extract an information about the signal name, a start bit, a signal size, a message type, a message name, an identifier, a message size, a cycle, a transmitter, a net name, whether a standardization is applied, and a receiver according to a predetermined message frame and signal format; and generating the first data frame to include the extracted information.

In some embodiments, generating the second data frame may include reading the message size from the first data frame, and changing a value of the message size into a different value depending on a protocol to be changed.

In some embodiments, generating the second data frame may further include reallocating the start bit based on the signal size.

In some embodiments, generating the second data frame may further include grouping messages for each cycle among a plurality of cycles and changing the message name of the messages grouped for each cycle.

In some embodiments, generating the second data frame may further include grouping the messages for each identifier among a plurality of identifiers, sorting the messages based on the identifier, and changing the identifier for the sorted messages.

In some embodiments, generating the second type CAN DBC file may include dividing the second data frame for each receiver to generate a plurality of second type CAN DBC files.

According to yet another embodiment, a non-transitory computer-readable media storing instructions executable by a computing device including a communication interface is provided. The instructions, when executed by one or more processors of the computing device, cause the computing device to: receive a first type CAN DBC file, receiving a configuration file including a CAN equipment name, a path of the first type CAN DBC file, a message name, a signal name, and information about a receiving device; parsing the configuration file to extract the signal name; extracting, from the first type CAN DBC file, a line corresponding to the signal name extracted from the configuration file; generating a first data frame by configuring the information included in the line according to a second type format different from the first type CAN DBC file; generating a second data frame by converting values of at least some items in the first data frame to a different format; and generating a second type CAN DBC file based on the second data frame.

### BRIEF DESCRIPTION OF THE DRAWINGS

FIG. 1 is a view for explaining a file conversion device according to an embodiment.

FIGS. 2-10 are views for explaining an operation of a file conversion device according to an embodiment.

FIG. 11 is a view for explaining a file conversion method according to an embodiment.

FIG. 12 is a view for explaining a computing device according to an embodiment.

### DETAILED DESCRIPTION

Hereinafter, embodiments of the present disclosure are described in detail with reference to the accompanying drawings. As those having ordinary skill in the art should realize, the described embodiments may be modified in various different ways, all without departing from the spirit and scope of the present disclosure. Accordingly, the drawings and description should be regarded as illustrative in nature and not limiting. Like reference numerals designate like elements throughout the specification.

In addition, unless explicitly described to the contrary, words such as “comprise” and “include”, and variations such as “comprises”, “comprising”, “includes”, and “including” should be understood to imply the inclusion of stated elements but not the exclusion of any other elements. Terms including ordinal numbers such as first, second, and the like are used only to describe various components, and should not be interpreted as limiting these components. The terms are merely used to differentiate one component from other components.

Terms “-er”, “-or”, and “module” described in the specification mean units for processing at least one function and operation, and may be implemented by hardware components or software components and combinations thereof. In addition, at least some of configurations or functions of file conversion methods and devices according to embodiments described herein may be implemented as a program or software, and the program or software may be stored in a non-transitory computer-readable recording medium or storage medium.

In the present disclosure, when a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

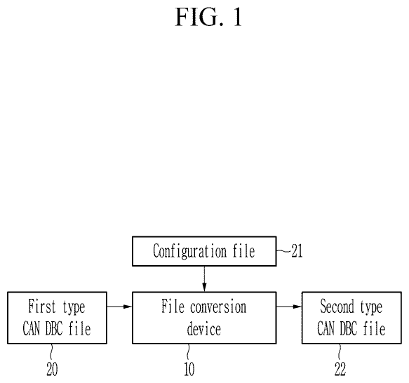

FIG. 1 is a view for explaining a file conversion device according to an embodiment.

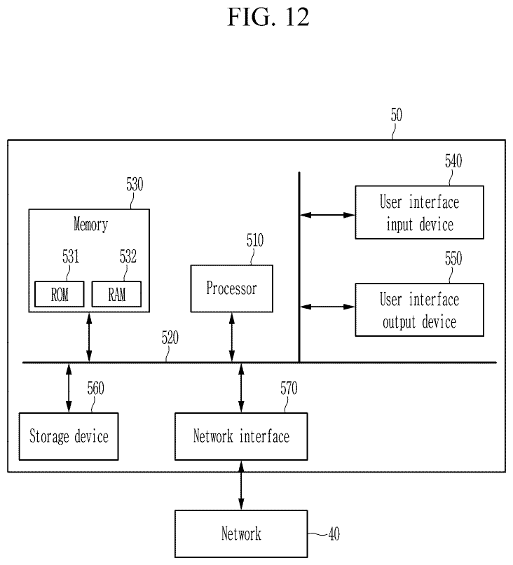

Referring to FIG. 1, a file conversion device 10 according to an embodiment may be implemented as a computing device including a processor and a memory. For example, the file conversion device 10 may be implemented as a computing device 50 as described below with reference to FIG. 12. In this case, the processor may correspond to a processor 510 of the computing device 50, and the memory may correspond to a memory 520 of the computing device 50. In some embodiments, the file conversion device 10 may include one or more non-transitory computer-readable media including instructions and one or more processors for executing the instructions to perform operations. The operations may include the configuration, function, step, etc. described in this specification for the file conversion method and device according to the embodiments. In this specification, the term “module” is used to logically distinguish these operations performed by the file conversion method and device according to the embodiments.

The processing for automatic DBC generation performed by the file conversion device 10 may be performed as follows. First, a signal information to be extracted from a conventional DBC may be input in YAML or Excel™ file format. The signal information to be extracted from the conventional DBC may include a CAN device name, a message name, a signal name, a receiving controller, etc. The file conversion device 10 may read the DBC file as a text and extract a BO_ (a message), a SG_ (a signal), a BA_ (an item), a VAL_ (a signal value), etc. by comparing them line by line. For the extracted signal information, the message name, a transmitter and receiver, an ID, etc. defined in the input are newly assigned or changed. All changed signal information may be stored in a new DBC file, and signals with the same message name may be reclassified and merged to reconfigure the start bit to fit the DBC syntax to avoid data waste and collision. All data may be framed and may be converted and stored per receiver to suit the needs of external platforms. Below, the details of the file conversion device 10, according to an embodiment, are described according to this flow.

The file conversion device 10 may receive a first type CAN DBC file 20 (i.e., a CAN DBC file of a first type) and a configuration file 21 and may output a second type CAN DBC file 22 (i.e., a CAN DBC file of a second type). In an embodiment, the first type CAN DBC file 20 may be, for example, a CAN DBC file that is difficult to leak to the outside, and the second type CAN DBC file 22 may be, for example, a CAN DBC file that can be leaked to the outside. The configuration file 21 may include the information about the CAN equipment name, the path of the first type CAN DBC file 20, the message name, the signal name, and the receiver.

In some embodiments, the configuration file 21 may include a plurality of CAN device names.

In this case, in the configuration file 21, the information about the path of the first type CAN DBC file 20, the message name, the signal name, and the receiver may be stored in a grouped format for each of the multiple CAN equipment names.

The file conversion device 10 may extract the signal name by parsing the configuration file 21 and may extract a line corresponding to the signal name extracted from the configuration file 21 from the first type CAN DBC file 20.

In some embodiments, the file conversion device 10 may sequentially read the first type CAN DBC file 20 line by line in one direction. The file conversion device 10 may determine whether a first line being read includes the signal name. Based on determining that the first line includes a signal name, the file conversion device 10 may extract the corresponding line. Additionally, the file conversion device 10 may read a second line of the first type CAN DBC file 20, after the first line, in the one direction. The file conversion device 10 may determine whether the signal name is included in the second line being read after the first line. Based on determining that the second line includes the signal name, the file conversion device 10 may extract the corresponding line.

In some embodiments, the file conversion device 10 may extract a BO line, a CM line, a BA line, and a VAL line corresponding to the signal name from the first type CAN DBC file 20 when extracting the line corresponding to the signal name extracted from the configuration file 21.

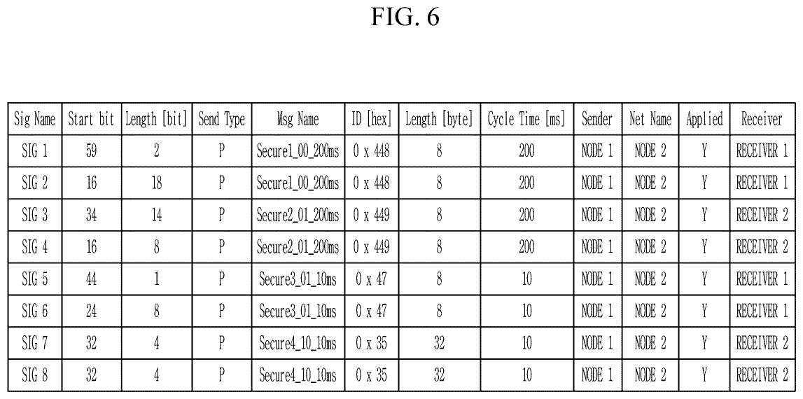

The file conversion device 10 may generate a first data frame by configuring the information included in the extracted line according to a second type format different from the first type. In an embodiment, the first data frame may correspond to an existing signal data frame as illustrated in FIG. 6.

In some embodiments, the file conversion device 10 may store (e.g., load) information included in the first line and information included in the second line into memory. The file conversion device 10 may analyze the information included in the first line and the information included in the second line according to a predetermined message frame and signal format, and may extract information about the signal name, the start bit, the signal size, the message type, the message name, an identifier, a message size, a cycle, a transmitter, a net name, whether a standardization is applied, and a receiver. The file conversion device 10 may generate a first data frame to include the extracted information.

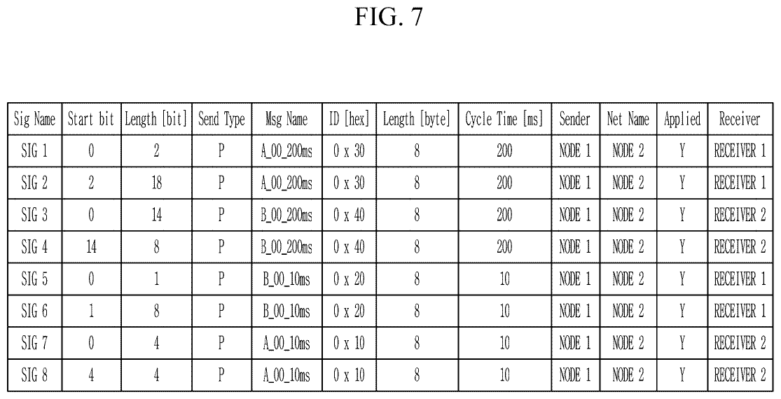

The file conversion device 10 may generate a second data frame by converting the values of some items in the first data frame into a different format. In an embodiment, the second data frame may correspond to a security signal data frame as illustrated in FIG. 7.

In some embodiments, the file conversion device 10 may, when generating the second data frame, read the message size from the first data frame and change the value of the message size to another value depending on the protocol to be changed. Additionally, the file conversion device 10 may reallocate the start bits based on the signal size. In addition, the file conversion device 10 may group the message by each cycle and may change the message name of the message grouped for each cycle. Additionally, the file conversion device 10 may group the message for each identifier, may sort the massages based on the identifier, and may change the identifier for the sorted list.

The file conversion device 10 may generate the second type CAN DBC file 22 from the second data frame.

In some embodiments, the file conversion device 10 may generate a plurality of second type CAN DBC files by dividing the second data frame for each receiver.

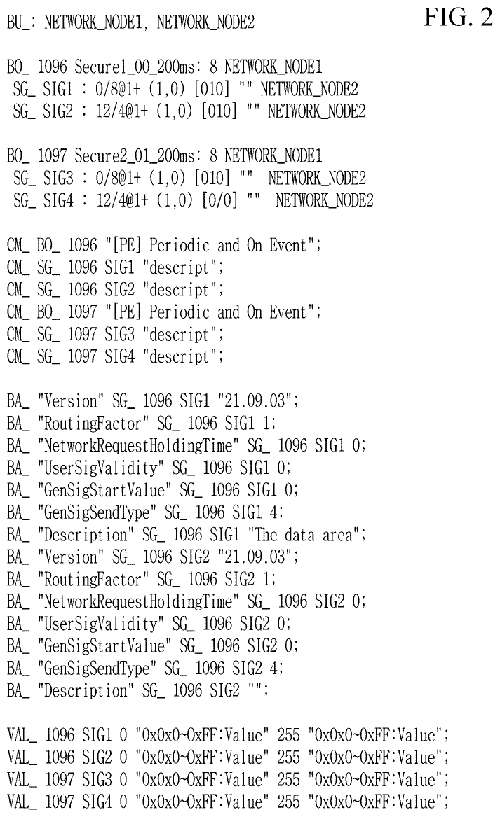

Below, the operation of the file conversion device 10, according to an embodiment, is described in more detail with reference to FIG. 2-10.

FIGS. 2-10 are views for explaining an operation of a file conversion device according to an embodiment.

FIG. 2 illustrates a first type CAN DBC file, according to an embodiment. The first type CAN DBC file may correspond to a CAN DBC files that is difficult to leak externally.

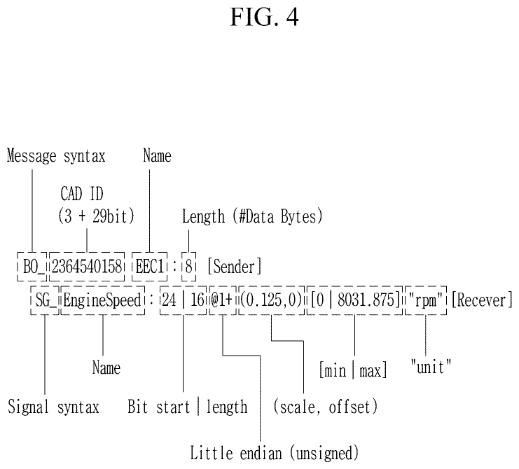

The first type CAN DBC file is a database format that defines the structure and information of a vehicle CAN data and may be composed of following sections:
1. Version and new symbols: information about the version of a DBC file and symbols used are included, and these values corresponding thereto are predetermined by a default and are not changed.
2. Baud rate definition: a CAN communication data transmission rate is defined and is automatically allocated according to a CAN protocol.
3. Definition of network node: a list of nodes included in the CAN network is provided.
4. Definition of the message frame and signals: information about the message frame and signals is included. The structure of the information, according to an embodiment, is as shown in FIG. 4.
5. Annotation section: Annotations are written in a format of CM_ SG_ (message ID) (signal name) (“description”), and an annotation target is distinguished as a node (“BU_”), a message (“BO_”), or a signal (“SG_”). The message ID is a decimal number representing the message to which the signal belongs.
6. Attribute definition part: basic input values and attributes of the signal are defined in a format of BA_ (item) SG (message ID) (signal name) (input value). The message ID is expressed in a decimal number.
7. Value table section: signal values and descriptions are defined in a format of VAL_ (message ID) (signal name) (value) (“description”). The message ID is a decimal representation of the message to which the signal belongs, and the value and description following the signal name represent the contents of the defined value table. This makes it clear what symbols or meanings are used for the valid values of the signal.

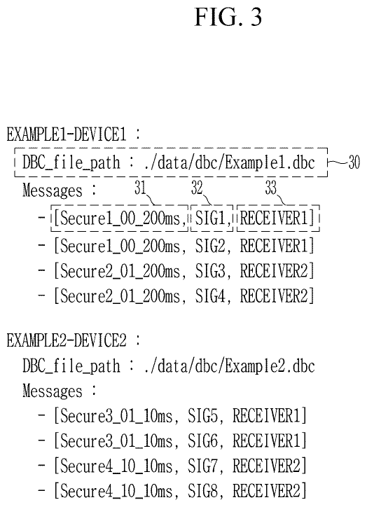

FIG. 3 illustrates the configuration file, according to an embodiment. In the configuration file, a path 30 of the first type CAN DBC file, a message name 31, a signal name 32 and information 33 about the receiving device may be stored in a grouped format for each of the plurality of CAN equipment names.

For example, the configuration file may store the path 30 of the first type CAN DBC file for the CAN device identified as “EXAMPLE-DEVICE1” as “,/data/dbc/Example1.dbc”. Additionally, the configuration file may store “Secure1_00_200ms” as the message name 31, “SIG1” as the signal name 32, and “RECEIVER1” as the information about the receiving device 33. As illustrated, such information may be stored in a format grouped for each CAN equipment name.

The file conversion device 10 reads a YAML file, for example, by utilizing the YAML library. First, parsing is sequentially started from the topmost signal and the information of “SIG1” is expected to be loaded from the file called “Example1.dbc”. The file conversion device 10 sequentially reads the first type CAN DBC file “Example1.dbc” shown in FIG. 2 in one direction.

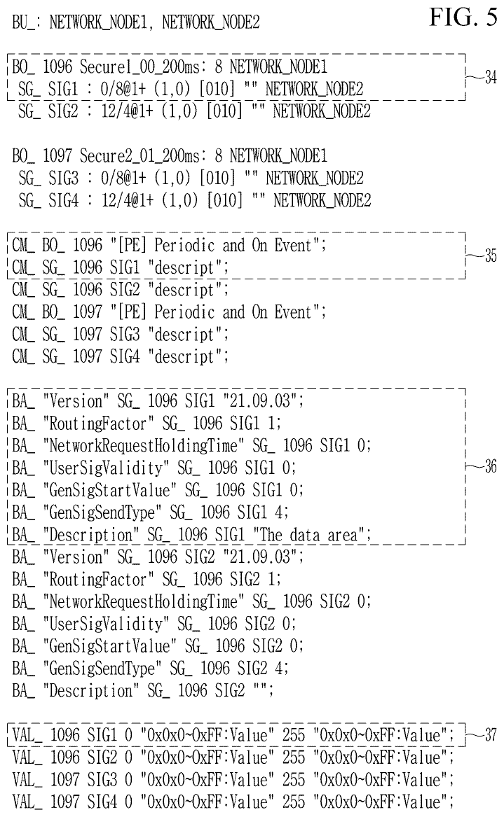

The file conversion device 10, as illustrated in FIG. 5, compares a BO_(message) and SG_(signal) 34, a CM_ (content) 35, a BA_(item) 36, and a VAL_(signal value) 37 line by line along with the “Secure1_00_200ms” message including “SIG1” in the first type CAN DBC file “Example1.dbc” to extract necessary information.

Referring to FIGS. 3-5, when the extraction of “SIG1” is finished, the file conversion device 10 compares the BO_(message) and SG_(signal) 34, the CM_ (content) 35, the BA_(item) 36, and the VAL_(signal value) 37 line by line to extract “SIG2”, “SIG3”, “SIG4”, . . . , “SIG8”. The information about all signals may be stored in the memory as strings.

By utilizing the message frame and signal format described in the DBC illustrated in FIG. 5, the information of each signal is classified into the signal name, the start bit, the signal size, the message type, the message name, the ID, the message size, the cycle, the transmitter, the network name (Net name), the absence of the standardization application, the receiver, etc., and then stored in the form of a data frame as illustrated in FIG. 6. FIG. 6 illustrates the existing signal data frame, according to an embodiment.

The existing signal data frame illustrated in FIG. 6 may be converted into the secure signal data frame illustrated in FIG. 7 by modifying the signal information according to the gateway standardization design for the CAN data routing between the vehicle and an external platform. Based on checking whether each message is a FD (32 bytes) or a HS (8 bytes), bytes are allocated according to the protocol to be changed, the start bit may set to 0 from the first signal within the same message based on the signal length, and the start bits may be sequentially reallocated according to the signal size. All messages may be grouped for each cycle (e.g. 10 ms, 50 ms, 100 ms, 200 ms, etc.) and new message names may be generated, for example by assigning letters (A, B, C, etc.) to the messages divided for each cycle. Afterwards, all messages may be grouped for each ID. The IDs may be sorted in an ascending order, and may be reassigned starting from the smallest ID, such as 10, 20, 30, etc. In this way, the signal position may be changed by reallocating the start bit, and the traceability of the existing signals may be reduced by changing the message name and the ID for each cycle, thereby enhancing the message security.

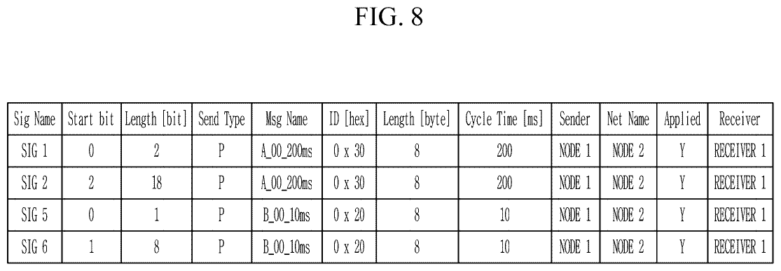

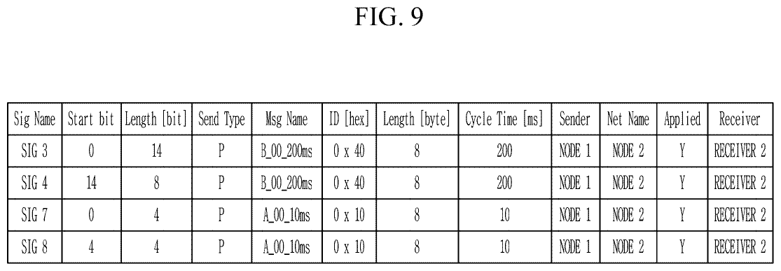

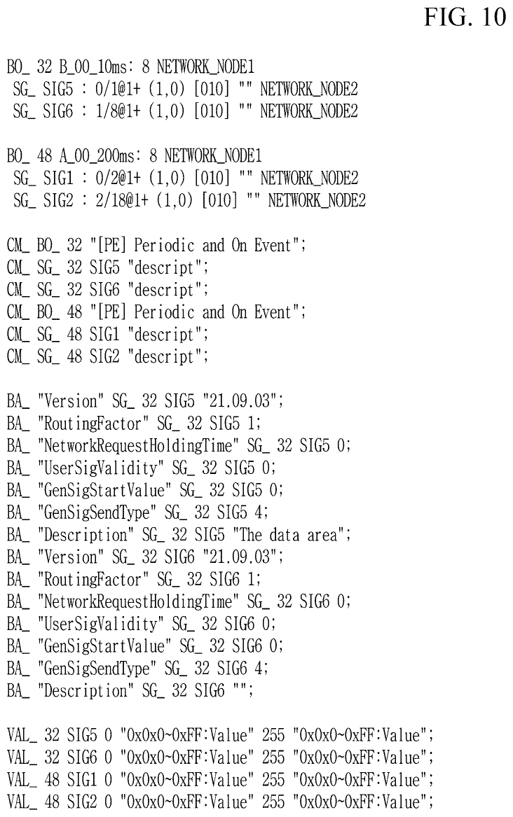

Based on the data frames processed so far, the data frames may be divided according to the receiver. In the case of FIG. 8, the data frame may be a data frame provided to some external company, and in the case of FIG. 9, the data frame may be a data frame provided to some other external company. And as illustrated in FIG. 10, a DBC file may be generated based on each divided data frame. The generated DBC file may be a second type CAN DBC file.

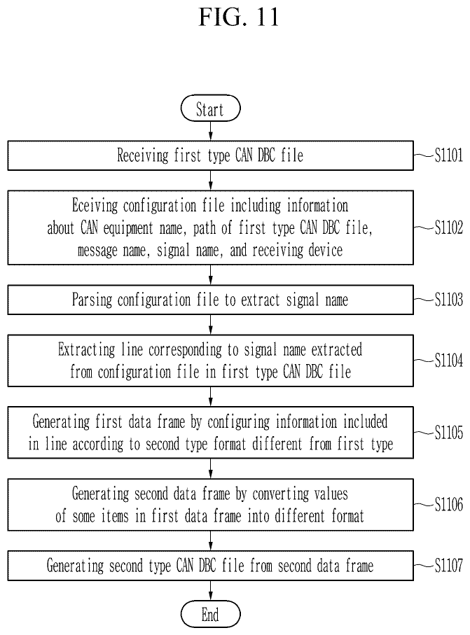

FIG. 11 is a view for explaining a file conversion method according to an embodiment.

Referring to FIG. 11, a file conversion method according to an embodiment may include an operation S1101 of receiving a first type CAN DBC file. The file conversion method may also include an operation S1102 of receiving a configuration file including a CAN equipment name, a path of the first type CAN DBC file, a message name, a signal name, and information about a receiving device. The file conversion method may additionally include an operation S1103 of parsing the configuration file to extract a signal name. The file conversion method may further include an operation S1104 of extracting, from the first type CAN DBC file, a line corresponding to a signal name extracted from the configuration file. The file conversion method may additionally include an operation S1105 of generating a first data frame by configuring information included in the line according to a second type format different from the first type. The file conversion may further include an operation S1106 of generating a second data frame by converting values of at least some items in the first data frame into a different format. The file conversion method may further still include an operation S1107 of generating a second type CAN DBC file based on the second data frame.

In some embodiments, the second type CAN DBC file may be subsequently used to route CAN data from a vehicle (e.g., a vehicle equipped with PBV) and an external platform.

For more detailed information on the above method, the reference may be made to the descriptions of other embodiments included in this specification, so redundant descriptions have been omitted.

FIG. 12 is a view for explaining a computing device according to an embodiment.

Referring to FIG. 12, the file conversion method and device according to embodiment of the present disclosure may be implemented by a computing device 50. The computing device 50 may be implemented as various types of electronic devices, servers or similar devices, and their functions may be implemented through a combination of software and hardware.

The computing device 50 may include at least one of the processor 510, the memory 530, a user interface input device 540, a user interface output device 550, and/or a storage device 560 communicating via a bus 520. The computing device 50 may also include a network interface 570 electrically connected to a network 40. The network interface 570 may transmit or receive signals to or from other entities via the network 40.

The processor 510 may be implemented as various types of computational units, such as an MCU (Micro Controller Unit), an AP (Application Processor), a CPU (Central Processing Unit), a GPU (Graphic Processing Unit), an NPU (Neural Processing Unit), a QPU (Quantum Processing Unit), etc. The processor 510 may be a semiconductor device that executes instructions stored in the memory 530 or the storage device 560 and may play a key role in the system. Program codes and data stored in the memory 530 or the storage device 560 instruct the processor 510 to perform specific tasks, thereby enabling the overall operation of the system. The processor 510 may be configured to implement various functions and methods described above with reference to FIGS. 1-11.

The memory 530 and the storage device 560 may include various forms of volatile or non-volatile storage media for storing and accessing data of the system. For example, the memory 530 may include a read-only memory (ROM) 531 and a random access memory (RAM) 532. In some embodiments, the memory 530 may be built into the processor 510, in this case, a data transfer speed between the memory 530 and the processor 510 may be very fast. In some other embodiments, the memory 530 may be located outside the processor 510, in which case the memory 530 may be connected to the processor 510 via various data buses or interfaces. This connection may be made through a variety of already known means, for example, a Peripheral Component Interconnect Express (PCIe) interface for high-speed data transfer or through a memory controller.

In some embodiments, at least some of the components or functions of the file conversion methods and devices according to embodiments of the present disclosure may be implemented as a program or software running on the computing device 50, and the program or software may be stored on a non-transitory computer-readable recording medium or storage medium. For example, a computer-readable recording medium or storage medium according to an embodiment may be a computer having recorded thereon a program for causing a computer including the processor 510 that executes a program or command stored in the memory 530 or the storage device 560 to execute steps included in the implementation of a file conversion method and device according to the embodiments.

In some embodiments, at least some of the components or functions of the file conversion methods and devices according to the embodiments may be implemented using hardware or circuitry of the computing device 50, or may be implemented as separate hardware or circuitry that may be electrically connected to the computing device 50.

In some embodiments, the computing device 50 may be provided with one or more non-transitory computer-readable media including executable instructions, which, when executed by one or more processors of the computing device 50, cause the computing device 50 to perform operations. The operation may include the configuration, function, steps, etc. described in this specification with respect to the file conversion method and device according to the embodiments.

According to embodiments, a library that automatically generates a gateway DBC to efficiently route CAN data between a vehicle and an external platform may be provided. The library according to the embodiments may automatically generate DBC files as well as convert them into various formats upon request or need. For example, the library may support converting the DBC files to other data formats, such as a CSV, so that they may be utilized on external platforms. This may greatly improve data management and compatibility, and may provide a flexible data processing environment tailored to user needs.

While the present disclosure has been described in connection with example embodiments, it should be understood that the present disclosure is not limited to the described embodiments. On the contrary, the present disclosure is intended to cover various modifications and equivalent arrangements included within the spirit and scope of the appended claims.

What is claimed is:

1. A file conversion method for converting a controller area network (CAN) database container (DBC) file including information related to CAN communication into another type, the file conversion method comprising:
receiving, by a processor, a first type CAN DBC file;
receiving, by the processor, a configuration file including a CAN equipment name, a path of the first type CAN DBC file, a message name, a signal name, and information about a receiving device;
parsing, by the processor, the configuration file to extract the signal name;
extracting, by the processor from the first type CAN DBC file, a line corresponding to the signal name extracted from the configuration file;
generating, by the processor, a first data frame by configuring information included in the line according to a second type format different from the first type CAN DBC file;
generating, by the processor, a second data frame by converting values of at least some items from the first data frame into another format; and
generating, by the processor, a second type CAN DBC file based on the second data frame.

2. The file conversion method of claim 1, wherein:
the configuration file includes a plurality of CAN equipment names; and
the configuration file stores the path, the message name, the signal name, and the information about the receiving device in a grouped format for each of the plurality of CAN equipment names.

3. The file conversion method of claim 1, wherein extracting the line corresponding to the signal name includes:
sequentially reading, by the processor, the first type CAN DBC file in one direction;
determining whether the signal name is included in a first line being read from the first type CAN DBC file;
extracting, by the processor, the first line based on determining that the signal name is included in the first line;
reading, by the processor, a second line of the first type CAN DBC file after the first line;
determining whether the second line being read from the first type CAN DBC file includes the signal name; and
extracting, by the processor, the second line based on determining that the signal name is included in the second line.

4. The file conversion method of claim 1, wherein extracting the line corresponding to the signal name includes extracting, by the processor, a message line, a content line, an item line, and a value line corresponding to the signal name from the first type CAN DBC file.

5. The file conversion method of claim 3, wherein generating the first data frame includes:
storing, by the processor, information included in the first line and information included in the second line in a memory;
analyzing, by the processor, the information included in the first line and the information included in the second line according to a predetermined message frame and signal format, to extract information about the signal name, a start bit, a signal size, a message type, a message name, an identifier, a message size, a cycle, a transmitter, a net name, whether a standardization is applied, and a receiver; and
generating, by the processor, the first data frame to include the extracted information.

6. The file conversion method of claim 5, wherein generating the second data frame includes:
reading, by the processor, the message size from the first data frame; and
changing, by the processor, a value of the message size to a different value according to a protocol to be changed.

7. The file conversion method of claim 6, wherein generating the second data frame includes reallocating, by the processor, the start bit based on the signal size.

8. The file conversion method of claim 6, wherein generating the second data frame further includes grouping, by the processor, messages for each cycle, among a plurality of cycles, and changing a message name of the messages grouped by the cycle.

9. The file conversion method of claim 8, wherein generating the second data frame further includes:
grouping, by the processor, messages for each identifier among a plurality of identifiers;
sorting the messages based on the identifier; and
changing the identifier for the sorted messages.

10. The file conversion method of claim 5, wherein generating the second type CAN DBC file includes dividing, by the processor, the second data frame by the receiver to generate a plurality of second type CAN DBC files.

11. A file conversion device comprising:
one or more non-transitory computer-readable media storing computer-readable instructions; and
one or more processors configured to execute the computer-readable instructions to
receive a first type controller area network (CAN) database container (DBC) file,
receive a configuration file including a CAN equipment name, a path of the first type CAN DBC file, a message name, a signal name, and information about a receiving device,
parse the configuration file to extract the signal name,
extract, from the first type CAN DBC file, a line corresponding to the signal name extracted from the configuration file,
generate a first data frame by configuring the information included in the line according to a second type format different from the first type CAN DBC file,
generate a second data frame by converting values of at least some items in the first data frame to a different format, and
generate a second type CAN DBC file from the second data frame.

12. The file conversion device of claim 11, wherein:
the configuration file includes a plurality CAN device names; and
the configuration file stores the path, the message name, the signal name, and the information about the receiving device in a grouped format for each of the CAN device names.

13. The file conversion device of claim 11, wherein extracting the line corresponding to the signal name includes:
determining whether a first line, read from the first type CAN DBC file, includes the signal name, while sequentially reading the first type CAN DBC file in one direction;
extracting the first line based on determining that the signal name is included in the first line;
determining whether a second line read after the first line includes the signal name, while reading the first type CAN DBC file in the one direction; and
extracting the second line based on determining that the signal name is included in the second line.

14. The file conversion device of claim 13, wherein generating the first data frame includes:
storing information included in the first line and information included in the second line in a memory;
analyzing the information included in the first line and the information included in the second line to extract information about the signal name, a start bit, a signal size, a message type, a message name, an identifier, a message size, a cycle, a transmitter, a net name, whether a standardization is applied, and a receiver according to a predetermined message frame and signal format; and
generating the first data frame to include the extracted information.

15. The file conversion device of claim 14, wherein generating the second data frame includes:
reading the message size from the first data frame; and
changing a value of the message size into a different value depending on a protocol to be changed.

16. The file conversion device of claim 15, wherein generating the second data frame further includes reallocating the start bit based on the signal size.

17. The file conversion device of claim 15, wherein generating the second data frame further includes grouping messages for each cycle, among a plurality of cycles, and changing the message name of the messages grouped for each cycle.

18. The file conversion device of claim 17, wherein generating the second data frame further includes:
grouping the messages for each identifier among a plurality of identifiers;
sorting the messages based on the identifier; and
changing the identifier for the sorted massages.

19. The file conversion device of claim 14, wherein generating the second type CAN DBC file includes dividing the second data frame for each receiver to generate a plurality of second type CAN DBC files.

20. One or more non-transitory computer-readable media storing computer-readable instructions that, when executed by one or more processors, cause the one or more processors to:
receive a first type controller area network (CAN) database container (DBC) file;
receive a configuration file including a CAN equipment name, a path of the first type CAN DBC file, a message name, a signal name, and an information about a receiving device;
parse the configuration file to extract the signal name;
extract, from the first type CAN DBC file, a line corresponding to the signal name extracted from the configuration file;
generate a first data frame by configuring the information included in the line according to a second type format different from the first type CAN DBC file;
generate a second data frame by converting values of at least some items in the first data frame to a different format; and
generate a second type CAN DBC file from the second data frame.
